(19) United States
(12) Patent Application Publication
(10) Pub. No.: US 2014/0203154 A1
(43) Pub. Date: Jul. 24, 2014

(54) SUPPORT APPARATUS

(71) Applicant: Eagle FAN, Chu-Pei City (TW)

(72) Inventor: Eagle FAN, Chu-Pei City (TW)

(21) Appl. No.: 13/744,747

(22) Filed: Jan. 18, 2013

(51) Int. Cl. F16M 13/02

(52) U.S. Cl. CPC F16M 13/02
USPC 248/205.5

(57) ABSTRACT

A support apparatus is provided, including a suction unit, a support unit and an engaging unit. The support unit includes a support frame and a locking element. The engaging unit is adjustably engaged to one end of the support frame. The support frame has a shape of a curvy board, with a side view showing an arc. The middle of the support frame includes a long hole, and the locking element passes the long hole to lock the support frame onto the top of the suction unit. By adjusting the position of the locking element in the long hole to change the locked position between the support frame and the suction unit, the height and the position of the engaging unit

### FIELD OF THE INVENTION

The present invention generally relates to a support apparatus, and more specifically to a support structure having a support formed by a curvy board with an arc side view for convenient use.

### BACKGROUND OF THE INVENTION

Portable electronic devices are rapidly penetrating every aspect of modern lives. With touch screen and wide range of applications, portable devices, such as, smart phone, GPS, portable media player, e-book reader, media tablet, and so on, allow the users to use the devices indoors, outdoors and inside cars.

In general, to fix a portable electronic device inside a car for use, a clamping apparatus and a support apparatus must be used so that the clamping apparatus can clamp on the portable device and the support apparatus is connected to the clamping apparatus to support the clamping apparatus so that the clamping apparatus can be fixed to a suitable position inside the case, such as, on the dash board or the wind shield. The structure of the support apparatus is usually a linked bar or a inked bar set configured to support and position of the clamping apparatus in an adjustable manner.

### SUMMARY OF THE INVENTION

The primary object of the present invention is to provide a support apparatus, for supporting a portable electronic device. The support apparatus uses arc-shaped support for adjusting a locking position of the support frame to change the position of the supported portable electronic device.

To achieve the above object, the support apparatus of the present invention includes a suction unit, a support unit and an engaging unit. The support unit includes a support frame and a locking element. The engaging unit is adjustably engaged to one end of the support frame. The support frame has a shape of a curvy board, with a side view showing an arc. The middle of the support frame includes a long hole, and the locking element passes the long hole to lock the support frame onto the top of the suction unit. By adjusting the position of the locking element in the long hole to change the locked position between the support frame and the suction unit, the height and the position of the engaging unit.

In addition, because of the side view of the support frame shows a shape of an arc, when the engaging unit is adjusted to the highest position (i.e., the position of the locking element is at one end of the long hole away from the engaging unit), the center of mass of the engaging unit will curve in towards the suction unit. As such, the stability of the support apparatus is improved when placed standing.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the present invention;

FIG. 2 shows a first dissected view of the present invention;

FIG. 3 shows a second dissected view of the present invention;

FIG. 4 shows a first side view of the present invention;

FIG. 5 shows a second side view of the present invention; and

FIG. 6 shows a view of the present invention in actual application.

### DETAILED DESCRIPTION OF THE PREFERRED EMBODIMENTS

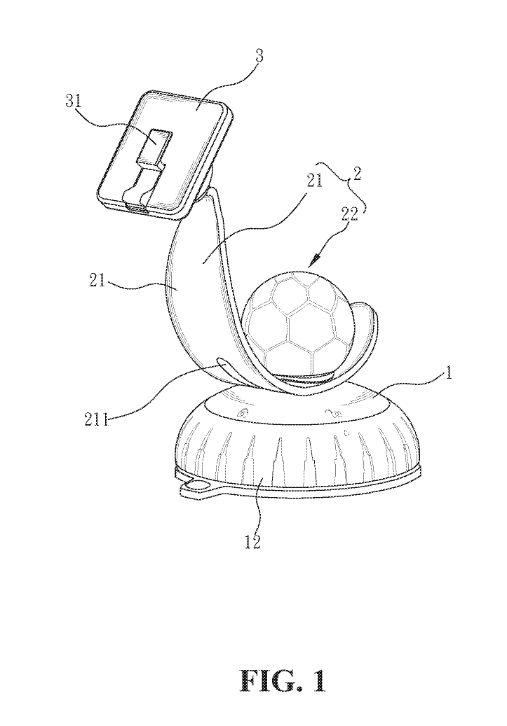

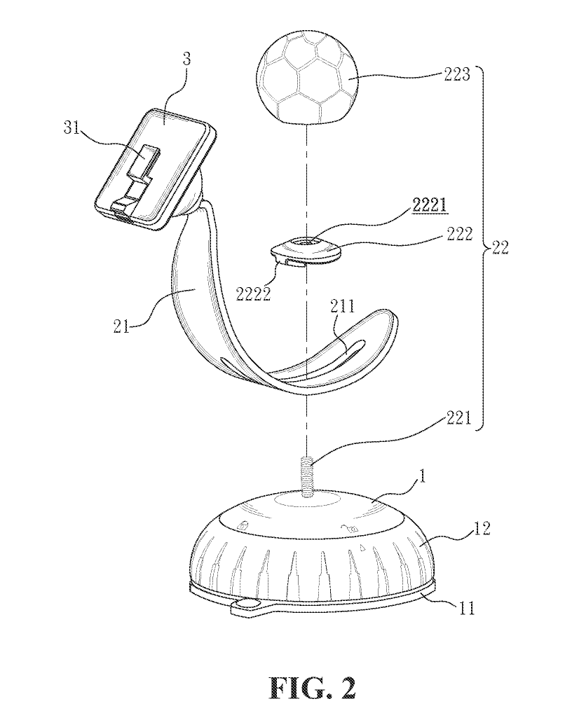

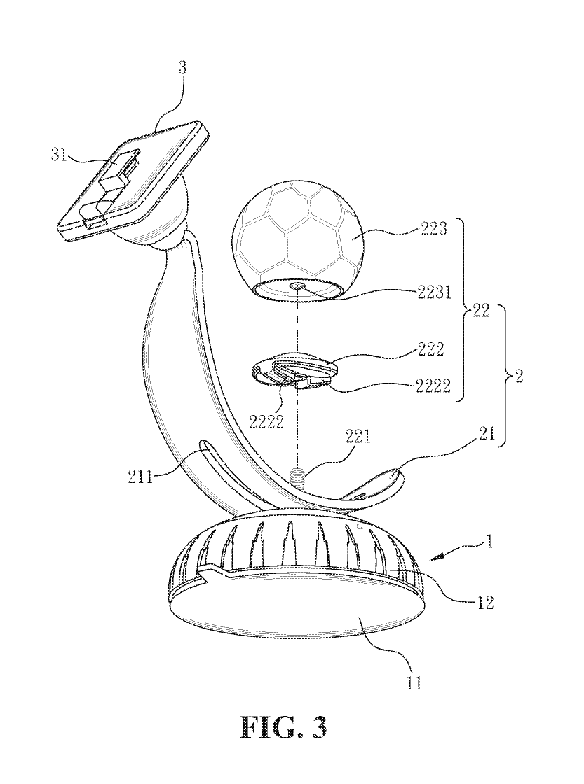

FIG. 1, FIG. 2 and FIG. 3 show a schematic view and dissected views of the present invention respectively. The support apparatus of the present invention includes a suction unit 1, a support unit 2 and an engaging unit 3. The suction unit 1 is for attaching to a surface so as to fix the support apparatus. A suction disk 11 is disposed at the bottom of the suction unit 1, and a rotation element 12 forms a body of the suction unit 1. When the rotation element 12 is rotates, a linked movement mechanism of the rotation element 12 facilitate the suction disk 11 to attach to a surface. The engaging unit 3 includes at least a buckle element 31 for buckling another element, for example, a clamping apparatus. The clamping apparatus can further clamp on to a portable electronic device. Alternatively if the portable electronic device is disposed with a structure matching corresponding to the buckling element 31, the portable electronic device can be engaged to the engaging unit 3 directly. The shape and structure of the buckling element 31 can be designed to match the different applications; thus, no specific restriction is imposed here.

The present invention is mainly to enhance the structure of the support unit 2. The support unit 2 includes a support frame 21 and a locking element 22. One end of the support frame 21 is adjustably connected to the engaging unit 3. The support frame 21 is a curvy board, with a side view of an arc. A long hole 211 is disposed at the center of the support frame 21, along the direction of the arc. The locking element 22 passes the long hole 21 to lock the support frame 21 onto the top of the suction unit 1. The position of the locking element 22 passing the long hole 211 can be changed, so that the locked position between the support frame 21 and the suction unit 1 can be adjusted for changing the height and the position of the engaging unit 3. In the present embodiment, the side view of the support frame 21 is an arc roughly a half circle, with an upwards opening. Thus, the trajectory of the long hole 211 also has the shape of a half-circle arc. For enhancement, the support frame 21 is made of metal material.

The locking element 22 is to lock the support frame 21 to the top of the suction unit 1 in a relievable manner. Various structures can also be used for this purpose. The embodiment described below is only for illustrative purpose, instead of restrictive purpose. As shown in FIG. 2 and FIG. 3, the locking element 22 of the present invention includes a bolt 221, a pressing element 222, and a knob 223. The bottom of the bolt is engaged to the top the suction unit 1. The pressing element 222 is a small round disk, with a hole 2221 at the center and at least a protruding element 2222 at the bottom of the disk. The bolt 221 passes through the hole 2221. The protruding element 2222 has a width lightly smaller than the width of the long hole 211. When assembled, the pressing element 222 is located at the top surface of the support frame, and the protruding element 2222 is inside the long hole 211. The knob 223 includes an inner screw thread 2231, matching the bolt 221. For assembling, the bolt 221 passes through, in the order of, the long hole 211 of the support frame 21 and the hole 2221 of the pressing element 222, to couple with the inner screw thread 2231 of the knob 223. When the knob 223 is loosened, the pressing element 222 does not press tightly against the surface of the support frame 21 so that the support frame 21 and slide along an arc trajectory in the long hole 211 to adjust the position of the bolt 221 inside the long hole 211 so as to adjust the position of the engaging unit 3. When the knob 223 is tightened, the pressing element 222 presses tightly against the top surface of the support frame 21 so that the support frame 21 is locked onto the suction unit 1. In addition, when the knob 223 is loosened, the support frame 21 can rotate around the bolt 221 so that the position of the engaging unit 3 at one end of the support frame 21 can also be adjusted horizontally.

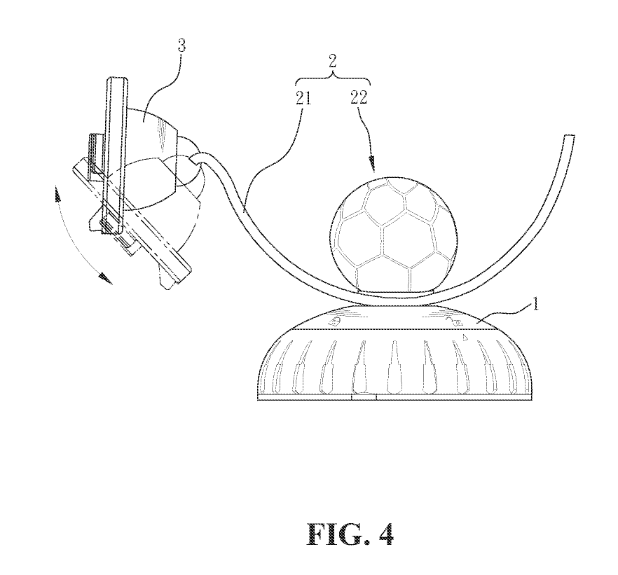

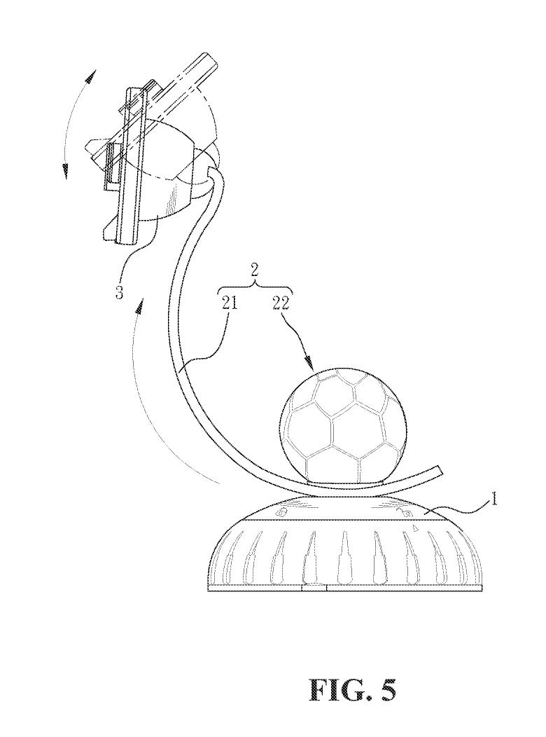

FIG. 4 and FIG. 5 show the present invention in s state of use. One end of the support frame 21 is adjustably connected to the engaging unit 3. The connection can be embodied with a ball-and-socket structure as in the present embodiment. However, the embodiment is only for illustrative purpose instead of restriction purpose. The engaging unit 3 can be adjusted along different direction. As shown in FIG. 4, in the present embodiment, the support frame 21 is locked by the locking element 22 at the middle section onto the top of the suction unit 1. At this point, the engaging unit 3 is at the lowest position. As shown in FIG. 5, the support frame 21 slides along the long hole 211, and the locking element 22 locks the support frame 21 at a position close to the end away from the engaging unit 3. At this point, engaging unit 3 is at the highest position. The engaging unit 3 is also adjustable to suitable angle for convenient engagement to another element. Because the support frame 21 has a half-circle arc shape, when the engaging unit 3 is at the highest position, the center of mass curves in closer to the suction unit 1 so as to enhance stability from tipping over.

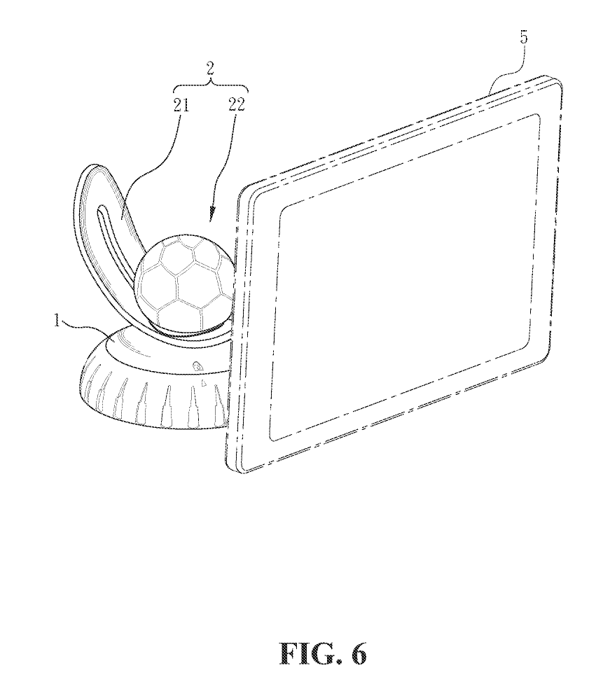

FIG. 6 shows a schematic view of the present invention in actual application with a portable electronic device. A portable electronic device 5 in FIG. 6 is disposed with a buckle element (not shown) at the back for engaging to the buckling element 31 of the engaging unit 3 to engage the portable electronic device 5 to one end of the support frame 21 of the support unit 2. The suction unit 1 is attached to a surface inside a car so that the portable electronic device 5 can be conveniently used inside the car.

In summary, the support apparatus of the present invention uses a support frame to connect a suction unit and an engaging unit, and uses the arc-shaped design, in combination with a locking element, to lock the support frame onto the top of the suction unit in an adjustable manner.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A support apparatus, comprising: a suction unit, a support unit and an engaging unit;
Wherein the support unit further comprising a support frame and a locking element, the engaging unit being adjustably connected to one end of the support frame; the supporting being a curvy board with a arc-shaped side view, and being disposed with a long hole in the middle of the board along the length direction of the board; the locking element passing through the long hole to lock the support frame onto the top of the suction unit, by adjusting the position of the locking element inside the long hole, locked position between the support frame and the suction unit being adjusted, so as to adjust the position of the engaging unit.

2. The support apparatus as claimed in claim 1, wherein the locking element further comprises a bolt, a pressing element, and a knob; wherein the bottom of the bolt is engaged to the top the suction unit; the pressing element is disposed with a hole for the bolt to pass through; the knob comprises an inner screw thread, matching the bolt; when assembled, the bolt passes through, in the order of, the long hole of the support frame and the hole of the pressing element, to couple with the inner screw thread of the knob.

3. The support apparatus as claimed in claim 2, wherein the pressing element is further disposed with at least a protruding element, having a width lightly smaller than the width of the long hole; when assembled, the pressing element is located at the top surface of the support frame, and the protruding element is inside the long hole.

4. The support apparatus as claimed in claim 1, wherein the arc-shape side view of the support frame is close to a half circle, and accordingly, the long hole has a trajectory of a half-circle arc.

5. The support apparatus as claimed in claim 1, wherein the support frame has an upward opening.

6. The support apparatus as claimed in claim 1, wherein the support frame is made of a metallic material.

7. The support apparatus as claimed in claim 1, wherein support frame and the engaging unit are connected by a ball-and-socket structure.
